(19) United States
(12) Patent Application Publication
(10) Pub. No.: US 2019/0051480 A1
(43) Pub. Date: Feb. 14, 2019

(54) OPERATING DEVICE

(71) Applicant: MITSUBISHI ELECTRIC CORPORATION, Chiyoda-ku, Tokyo (JP)

(72) Inventors: Satoru Maeno, Tokyo (JP); Tomohito Mori, Tokyo (JP); Daisuke Yoshida, Tokyo (JP)

(73) Assignee: MITSUBISHI ELECTRIC CORPORATION, Chiyoda-ku, Tokyo (JP)

(21) Appl. No.: 16/079,505

(22) PCT Filed: Mar. 25, 2016
(86) PCT No.: PCT/JP2016/059680

§ 371 Date: Aug. 23, 2018

(51) Int. Cl. H01H 50/44; H01H 50/18; H01H 50/36; H01H 50/64

(52) U.S. Cl. CPC H01H 50/44; H01H 50/641; H01H 50/36; H01H 50/18

(57) ABSTRACT

An operating device includes: a movable core reciprocally movable along an operational axis; a stationary core provided along the operational axis and facing the movable core; a first coil configured from a first wire wound in a cylindrical shape centered about the operational axis; and a second coil configured from a second wire wound around an outer side of the first coil in a cylindrical shape centered about the operational axis. The second wire has a larger wire diameter than the first wire.

### FIELD

The present invention relates to an operating device that moves a movable core by using magnetic flux generated in a coil.

### BACKGROUND

Conventional operating devices that move movable cores by using magnetic flux generated by energizing coils are in use. Patent Literature 1 discloses an operating device provided with two coils.

### CITATION LIST

### Patent Literature

Patent Literature 1: Japanese Patent Application Laid-open No. 2013-89516

### SUMMARY

### Technical Problem

With the configuration disclosed in Patent Literature 1 described above, the movable core is moved by energizing the inner coil and a low current is caused to flow in the outer coil for a long period of time in order to maintain a closed state. This means that the inner and outer coils are used for different purposes; therefore, the magnetic flux generated is different when the inner coil is energized and when the outer coil is energized. Thus, when the movable core is moved by energizing the outer coil, the moving speed of the movable core at this time is different from that when the movable core is moved by energizing the inner coil.

It is thus difficult to move the movable core in the same manner when the inner coil is energized and when the outer coil is energized and, in a case when an abnormality occurs in the energization system for one of the coils, to move the movable core by energizing the other coil so as to enable improvement in reliability of the operating device.

The present invention has been achieved in view of the above and an object of the present invention is to provide an operating device that can move a movable core at the same speed irrespective of which of the multiple coils is energized and can thus improve product reliability.

### Solution to Problem

In order to solve the above problems and achieve the object, an aspect of the present invention is an operating device including: a movable core reciprocally movable along an operational axis; a stationary core provided along the operational axis and facing the movable core; a first coil configured from a first wire wound in a cylindrical shape centered about the operational axis; and a second coil configured from a second wire wound around an outer side of the first coil in a cylindrical shape centered about the operational axis. The second wire has a larger wire diameter than the first wire.

### Advantageous Effects of Invention

The operating device according to the present invention produces an effect of improving product reliability by enabling the movable core to move at the same speed irrespective of which of the multiple coils is energized.

### BRIEF DESCRIPTION OF DRAWINGS

FIG. 1 is a cross-sectional view of an operating device according to a first embodiment of the present invention.

FIG. 2 is a plan view of an electromagnet according to the first embodiment.

FIG. 3 is a side view of the electromagnet according to the first embodiment.

FIG. 4 is a cross-sectional view taken along line A-A in FIG. 2.

FIG. 5 is a cross-sectional view of an electromagnet included in an operating device according to a modification of the first embodiment.

FIG. 6 is a cross-sectional view of an electromagnet included in an operating device according to a second embodiment of the present invention.

FIG. 7 is a cross-sectional view of an electromagnet included in an operating device according to a third embodiment of the present invention.

### DESCRIPTION OF EMBODIMENTS

An operating device according to embodiments of the present invention will be described below in detail with reference to the drawings. The embodiments are not intended to limit the present invention.

### First Embodiment

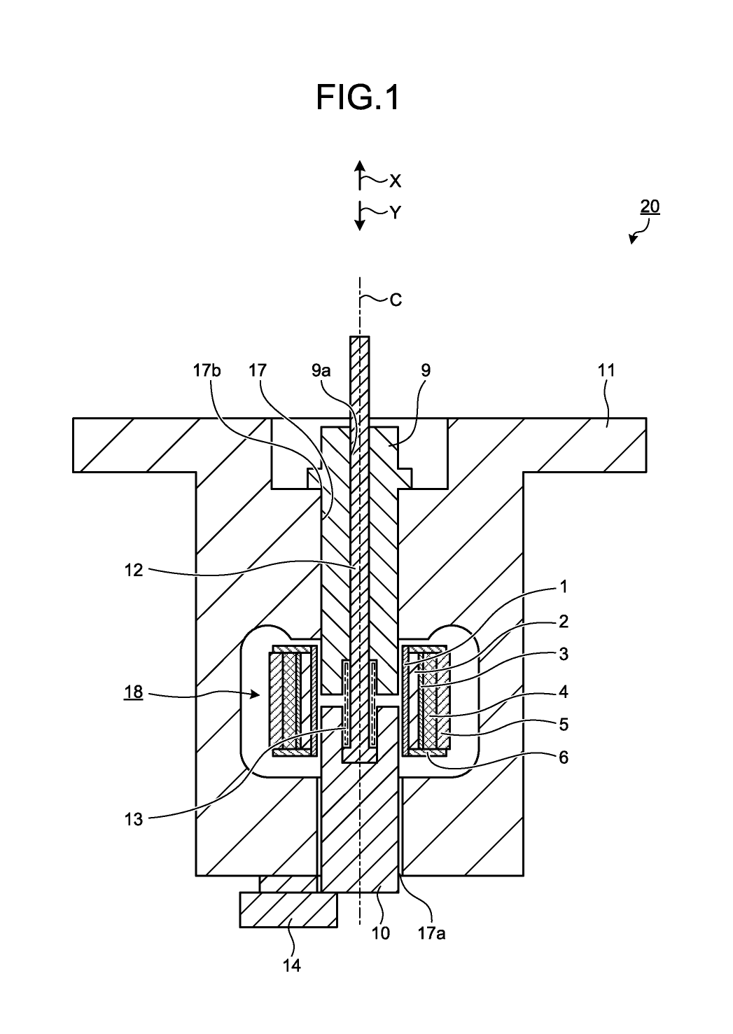

FIG. 1 is a cross-sectional view of an operating device according to a first embodiment of the present invention. An operating device 20 includes a yoke 11 formed with a hole 17 extending along an operational axis C. A stationary core 9 and a movable core 10 are provided in the hole 17 of the yoke 11 such that they face each other. The movable core 10 is provided on a side closer to one end 17a of the hole 17 and the stationary core 9 is provided on a side closer to the other end 17b of the hole 17.

The stationary core 9 is fixed in the hole 17. The movable core 10 is movable in the hole 17 along the operational axis C. The yoke 11 is provided with a stopper 14 that closes the end 17a of the hole 17 to prevent the movable core 10 from sliding out of the hole 17.

A biasing unit 13 is provided between the stationary core 9 and the movable core 10. The biasing unit 13 applies a biasing force in a direction that separates the stationary core 9 and the movable core 10 from each other. The biasing unit 13 is, for example, a coil spring. With the biasing force exerted by the biasing unit 13, a gap is formed between the stationary core 9 and the movable core 10.

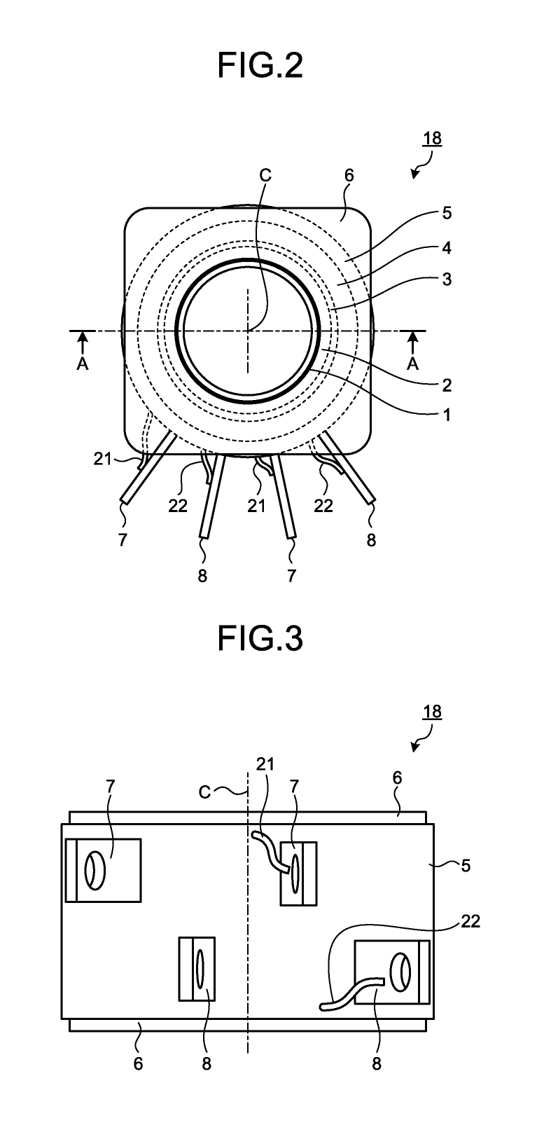

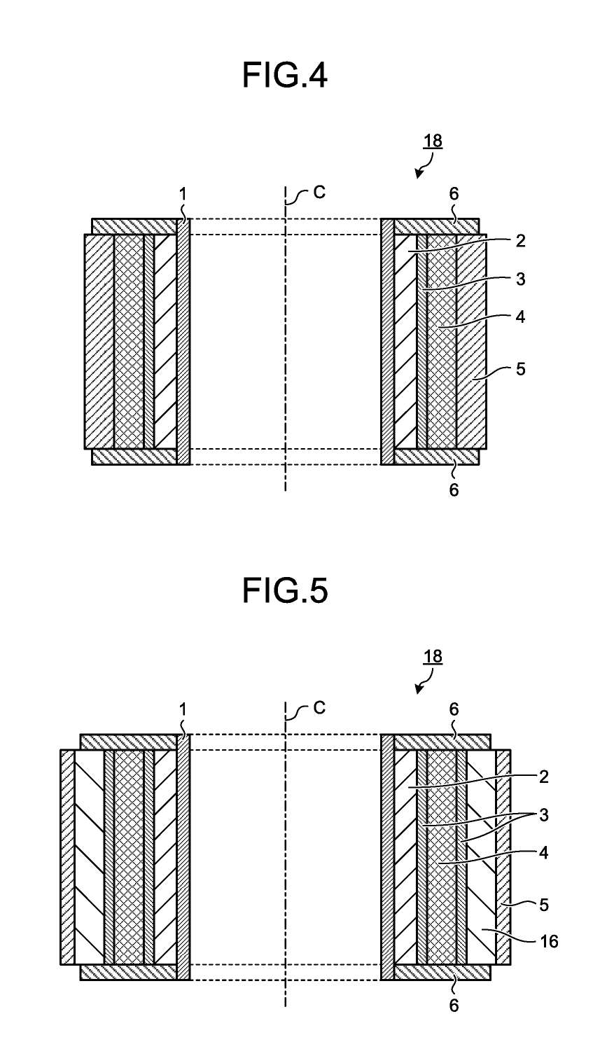

An electromagnet 18 is provided in the hole 17. The electromagnet 18 has a cylindrical shape centered about the operational axis C. FIG. 2 is a plan view of the electromagnet 18 according to the first embodiment. FIG. 3 is a side view of the electromagnet 18 according to the first embodiment. FIG. 4 is a cross-sectional view taken along line A-A in FIG. 2. FIGS. 2 to 4 illustrate the operational axis C of the operating device 20 as well.

In the electromagnet 18, a first coil 2 is provided on the outer side of a bobbin 1 and an insulator 3 is provided on the outer side of the first coil 2. The first coil 2 is formed by winding a conductive first wire 21 illustrated in FIG. 3 around the bobbin 1. Further, in the electromagnet 18, a second coil 4 is provided on the outer side of the insulator 3. The second coil 4 is formed by winding a conductive second wire 22 illustrated in FIG. 3 around the insulator 3.

The first wire 21 of the first coil 2 and the second wire 22 of the second coil 4 have the same number of turns, i.e., the same number of windings. The concept of “the number of windings is the same” in the specification includes a case when the number of windings of the first wire 21 is slightly different from that of the second wire 22. For example, a case when the relationship 0.8<(r1/r2)<1.2 is satisfied is also included in the concept of “the number of windings is the same”, where r1 indicates the number of windings of the first wire 21 of the first coil 2 and r2 indicates the number of windings of the second wire 22 of the second coil 4. Further, the second wire 22 has a larger wire diameter than the first wire 21.

Tape 5 is wrapped around the outside of the second coil 4, and first coil terminals 7 and second coil terminals 8 are fixed to the outside of the tape 5. The annular opposite end surfaces of the electromagnet 18 are covered with plate-shaped end plates 6. The ends of the first wire 21 are extracted to the outside through a gap between the insulator 3, the second coil 4 and the tape 5, and the end plates 6 and are connected to the first coil terminals 7 as illustrated in FIG. 3. The ends of the second wire 22 are extracted to the outside through a gap between the tape 5 and the end plates 6 and are connected to the second coil terminals 8 as illustrated in FIG. 3.

Power supply lines (not illustrated) are connected to the respective first coil terminals 7 and the respective second coil terminals 8. Each of the first coil terminals 7 and the second coil terminals 8 can be individually energized through the corresponding power supply line. This means that each of the first coil 2 and the second coil 4 can be individually energized.

The description here refers back to FIG. 1. The central position of the electromagnet 18 coincides with the position of the gap between the stationary core 9 and the movable core 10 in the direction along the operational axis C. More specifically, the central position of the first coil 2, the central positon of the second coil 4, and the position of the gap between the stationary core 9 and the movable core 10 coincide in the direction along the operational axis C.

A plunger 12 is fixed to the surface of the movable core 10 facing the stationary core 9. The plunger 12 has a bar-like shape and extends along the operational axis C. The stationary core 9 is formed with a through hole 9a extending along the operational axis C. The plunger 12 extends through the through hole 9a and projects from the other end 17b of the hole 17 of the yoke 11.

With the operating device 20 described above, an attractive force can be exerted between the stationary core 9 and the movable core 10 by generating magnetic flux by energizing the first coil 2 or the second coil 4. The attractive force acting between the stationary core 9 and the movable core 10 moves the movable core 10 toward the stationary core 9 against the biasing force of the biasing unit 13. Consequently, the plunger 12 fixed to the movable core 10 moves in the direction indicated by an arrow X. When the energization of the first coil 2 or the second coil 4 is stopped, the attractive force acting between the stationary core 9 and the movable core 10 disappears. As a result, the movable core 10 moves in a direction away from the stationary core 9 due to the biasing force of the biasing unit 13. Consequently, the plunger 12 fixed to the movable core 10 moves in the direction indicated by an arrow Y.

An operating lever for a gas insulated switchgear, for example, can be connected to the tip of the plunger 12. With this configuration, the operating lever can be operated by energizing or de-energizing the first coil 2 or the second coil 4.

In the operating device 20 according to the first embodiment, the first wire 21 and the second wire 22 have the same number of windings but the second coil 4 is further away from the operational axis C than the first coil 2; therefore, the second wire 22 is longer than the first wire 21 in total length.

Further, in the operating device 20, the second wire 22 has a larger wire diameter than the first wire 21; therefore, the second wire 22 has a lower electric resistance per unit length than the first wire 21.

For such reasons, although the second wire 22 of the second coil 4 is longer in total length than the first wire 21 of the first coil 2 in the operating device 20, the difference in electric resistance between the entire first wire 21 of the first coil 2 and the entire second wire 22 of the second coil 4 can be made smaller than the case when the first wire 21 and the second wire 22 have the same wire diameter.

Consequently, the first coil 2 and the second coil 4 when energized can generate the same amount of magnetic flux; therefore, the attractive force exerted between the stationary core 9 and the movable core 10 is the same when the first coil 2 is energized and when the second coil 4 is energized. In other words, the moving speed of the movable core 10 can be the same when the first coil 2 is energized and when the second coil 4 is energized.

For example, when the plunger 12 is connected to an operating lever for a gas insulator switchgear, the period of time until the operation is completed when the first coil 2 or the second coil 4 is energized can be made the same. A case is considered here where the first coil 2 is energized during normal conditions and the second coil 4 is used as a backup coil for a case when the first coil 2 cannot be energized. In such a case, when the first coil 2 cannot be energized for some reasons, the second coil 4 is energized so as to enable the movable core 10 to move at the same speed as in the case when the first coil 2 is energized. As described above, with the operating device 20 according to the first embodiment, the movable core 10 can be moved at the same speed irrespective of which coil is being energized and product reliability can be improved.

Furthermore, the central position of the first coil 2, the central positon of the second coil 4, and the position of the gap between the stationary core 9 and the movable core 10 coincide in the direction along the operational axis C; therefore, the gap between the stationary core 9 and the movable core 10 can be located in an area with higher flux density. Thus, the attractive force exerted by the magnetic flux generated from the first coil 2 or the second coil 4 can be maximized.

FIG. 5 is a cross-sectional view of the electromagnet 18 included in an operating device according to a modification of the first embodiment. In this modification, a third coil 16 is provided on the outer side of the second coil 4. When the triple coils 2, 4, and 16 are provided, the wire diameter of the third wire (not illustrated) wound as the third coil 16 is larger than that of the second wire 22. Consequently, the moving speed of the movable core 10 can be the same when the first coil 2 is energized, when the second coil 4 is energized, and when the third coil 16 is energized. Moreover, an increase in the number of backup coils can further improve product reliability. The number of coils is not limited to three as in this modification and it may be four or more. In other words, product reliability can be further improved by having multiple coils centered about the operational axis C such that the wire diameter of the wire wound around a coil on the outer side is larger than that of the wire wound around a coil on the inner side.

### Second Embodiment

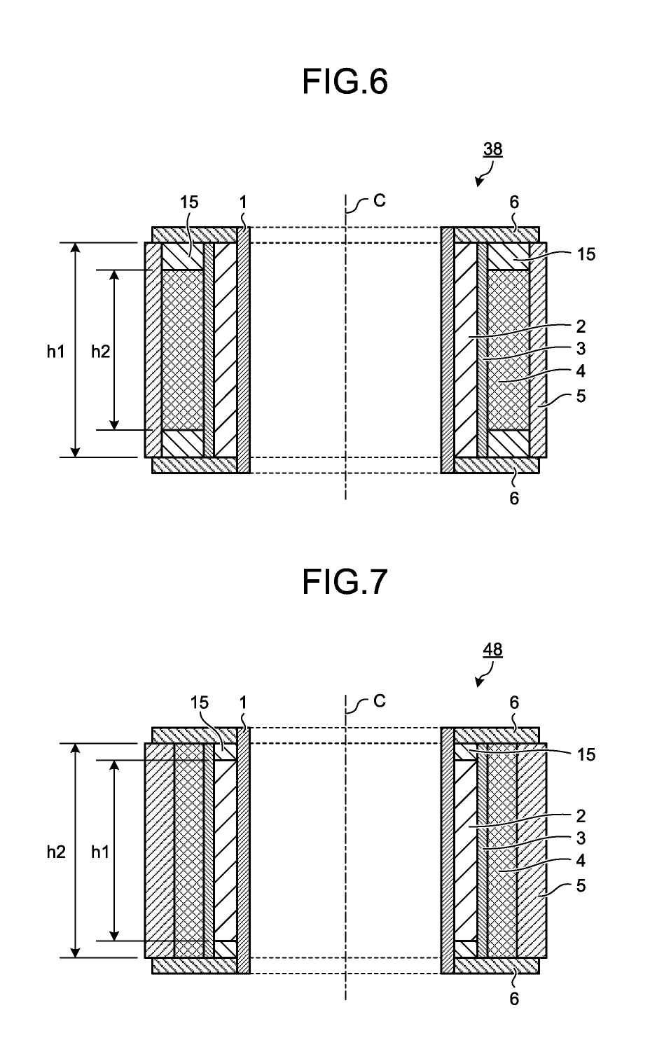

FIG. 6 is a cross-sectional view of an electromagnet included in an operating device according to a second embodiment of the present invention. The same configurations as those of the above-described embodiment are denoted by the same reference numerals and a description thereof is omitted. In an electromagnet 38, a length h2 of the second coil 4 is less than a length hl of the first coil 2 in the direction along the operational axis C. More specifically, the relationship 1<(h1/h2)<1.3 holds. Insulators 15 are provided in the gaps between the end plates 6 and the second coil 4. The central positon of the first coil 2 coincides with the central positon of the second coil 4 in the direction along the operational axis C.

In the second embodiment, the first wire 21 (see also FIG. 2) connected to the first coil terminals 7 can pass through the gap between the end plates 6 and the second coil 4 and this increases the ease of operations. Moreover, part of the first coil terminals 7 and the second coil terminals 8 can be embedded in the insulators 15; therefore, the electromagnet 38 can be reduced in size. The reduction in size of the electromagnet 38 results in a reduction in size of the operating device.

### Third Embodiment

FIG. 7 is a cross-sectional view of an electromagnet included in an operating device according to a third embodiment of the present invention. The same configurations as those of the above-described embodiments are denoted by the same reference numerals and a description thereof is omitted. In an electromagnet 48, the length hl of the first coil 2 is less than the length h2 of the second coil 4 in the direction along the operational axis C. More specifically, the relationship 0.7<(h1/h2)<1 holds. The insulators 15 are provided in the gaps between the end plates 6 and the first coil 2. The central positon of the first coil 2 coincides with the central positon of the second coil 4 in the direction along the operational axis C.

The configurations described in the above-mentioned embodiments indicate examples of the content of the present invention. The configurations can be combined with another known technique, and part of the configurations can be omitted or changed in a range without departing from the spirit of the present invention.

### REFERENCE SIGNS LIST

1 bobbin; 2 first coil; 3 insulator; 4 second coil; 5 tape; 6 end plate; 7 first coil terminal; 8 second coil terminal; 9 stationary core; 9a through hole; 10 movable core; 11 yoke; 12 plunger; 13 biasing unit; 14 stopper; 15 insulator; 16 third coil; 17 hole; 17a one end; 17b other end; 18, 38, 48 electromagnet; 20 operating device; 21 first wire; 22 second wire.

1. An operating device comprising:
a movable core reciprocally movable along an operational axis;
a stationary core provided along the operational axis and facing the movable core;
a first coil configured from a first wire wound in a cylindrical shape centered about the operational axis; and
a second coil configured from a second wire wound around an outer side of the first coil in a cylindrical shape centered about the operational axis, wherein
the second wire has a larger wire diameter than the first wire, and
the second coil is shorter than the first coil in a direction along the operational axis.

2. The operating device according to claim 1, wherein a central position of the first coil, a central position of the second coil, and a position of a gap between the movable core and the stationary core coincide in the direction along the operational axis.

3. (canceled)

4. The operating device according to claim 1, wherein
a relationship 1<(h1/h2)<1.3 holds,
where h1 indicates a length of the first coil in the direction along the operational axis and h2 indicates a length of the second coil in the direction along the operational axis.

5. (canceled)

6. An operating device comprising:
a movable core reciprocally movable alone an operational axis;
a stationary core provided along the operational axis and facing the movable core;
a first coil configured from a first wire wound in a cylindrical shape centered about the operational axis; and
a second coil configured from a second wire wound around an outer side of the first coil in a cylindrical shape centered about the operational axis, wherein
the second wire has a larger wire diameter than the first wire,
the first coil is shorter than the second coil in a direction along the operational axis, and
a relationship 0.7<(h1/h2)<1 holds,
where h1 indicates a length of the first coil in the direction along the operational axis and h2 indicates a length of the second coil in the direction along the operational axis.

7. (canceled)

8. The An operating device according to claim 1, further comprising:
a movable core reciprocally movable along an operational axis;
a stationary core provided along the operational axis and facing the movable core;
a first coil configured from a first wire wound in a cylindrical shape centered about the operational axis;
a second coil configured from a second wire wound around an outer side of the first coil in a cylindrical shape centered about the operational axis; and
a third coil configured from a third wire wound around an outer side of the second coil in a cylindrical shape centered about the operational axis, wherein
the second wire has a larger wire diameter than the first wire, and the third wire has a larger wire diameter than the second wire.

9. The operating device according to claim 2, wherein
a relationship 1<(h1/h2)<1.3 holds,
where h1 indicates a length of the first coil in the direction along the operational axis and h2 indicates a length of the second coil in the direction along the operational axis.
